(19) United States
(12) Patent Application Publication
(10) Pub. No.: US 2020/0297167 A1
(43) Pub. Date: Sep. 24, 2020

(54) Roundabout Cutting Board

(71) Applicant: Stephanie Ann Green, Milwaukie, OR (US)

(72) Inventor: Stephanie Ann Green, Milwaukie, OR (US)

(21) Appl. No.: 16/362,336

(22) Filed: Mar. 22, 2019

(51) Int. Cl. A47J 47/00

(52) U.S. Cl. CPC A47J 47/005

(57) ABSTRACT

The purpose of this patent application is to obtain a patent on the Roundabout Cutting Board. The main purpose for this invention is to benefit anyone who uses a cutting board to chop round vegetables/fruits. The recessed and grooved pockets act like a stabilization tool for the round side of fruits and vegetables to prevent it from slipping and cutting a finger. The intended audience is for cooks, home chefs and professional chefs at any cooking level. A huge audience will also be kid chefs to help them prevent cutting themselves. Moms will love this invention as it provides a safer cutting surface for their young chefs.

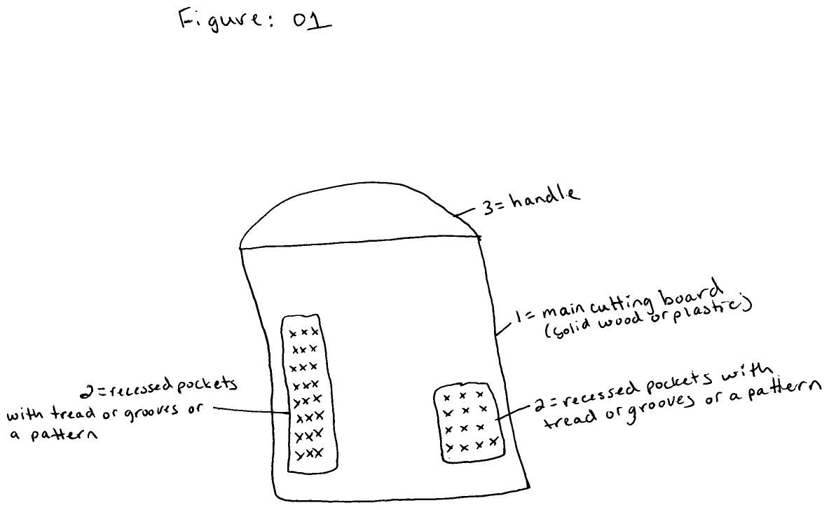

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention is a new invention in which no patents or ideas already exist. This is a brand new product that will be brought to the market. It is a new product and that is standalone. The main impetus for the Roundabout Cutting Board is to stabilize round fruit or vegetables to prevent them from slipping when you slice them.

A round fruit or vegetable is placed into the grooved area and the grooves prevent it from rolling and prevents your finger from being cut.

Stephanie Ann Green is a full time working mother of 3 small kids with an MBA. Her house is comprised of a family of 5 and she is always cooking and chopping vegetables. One day in 2018, she was cutting a round vegetable on a cutting board and the round vegetable slipped and she cut her finger to the bone. She then thought about creating a chopping board that has components embedded into it that helps prevent slippage of round vegetables when slicing them.

### BRIEF SUMMARY OF THE INVENTION

As mentioned above, there is a huge market and need for this product. The invention is a cutting board that has two pockets of grooves embedding into them. The main reason for this invention is for safety and to prevent cutting fingers while chopping vegetables or fruit.

### BRIEF DESCRIPTION OF THE SEVERAL VIEWS OF THE DRAWING

Please refer to the drawing which is located on a separate page. Each element is properly labeled.

### DETAILED DESCRIPTION OF THE INVENTION

There is no other invention like this one the market. The process is simple with existing materials on the market. All materials are on the market currently so it's a matter of assembling existing materials that are commercially available. This invention requires either plastic or wood-based materials that are commercially and readily available. They are molded into the shape of a cutting board with pockets that are cut out in order to hold or cradle round vegetables and the grooves stabilize them, so they do not slip. The cutting board has several pockets that are cut out and then filled with grooves that stabilize the vegetable. The person places a round or long vegetable onto the recessed and grooved pockets and starts to cut them. The grooves and recessed area stabilize the round side of the vegetable so it does not move. This cutting board is great for advanced chefs and new little chefs that are just learning to use a knife. The main reason for this invention is prevent fingers from being cut.

1. A cutting board used for chopping fruits and vegetables that has grooved pockets imbedded into the cutting board that stabilize round fruits and vegetables from moving and slipping while being cut.
(a) a cutting board made of wood or plastic material that has grooved and recessed pockets imbedded into the main part of the cutting board.
(b) the grooved and recessed pockets provide stabilization to any round vegetable or fruit while being cut.
